(19) United States
(12) Patent Application Publication
(10) Pub. No.: US 2022/0172062 A1
(43) Pub. Date: Jun. 2, 2022

(54) MEASURING CONFIDENCE IN DEEP NEURAL NETWORKS

(71) Applicant: Ford Global Technologies, LLC, Dearborn, MI (US)

(72) Inventor: Gurjeet Singh, Castro Valley, CA (US)

(73) Assignee: Ford Global Technologies, LLC, Dearborn, MI (US)

(21) Appl. No.: 17/108,292

(22) Filed: Dec. 1, 2020

(51) Int. Cl. G06N 3/08; G06N 3/04; G06K 9/62; G06K 9/00; G06F 17/18; B60W 50/00

(52) U.S. Cl. CPC G06N 3/084; G06N 3/0454; G06K 9/6212; G06K 9/6298; B60W 2050/0095; G06F 17/18; B60W 50/0097; B60W 2050/0005; G06K 9/00791

(57) ABSTRACT

A system comprises a computer including a processor and a memory, and the memory including instructions such that the processor is programmed to calculate a standard deviation of a plurality of predictions, wherein each prediction of the plurality of predictions is generated by a different deep neural network using sensor data; and determine at least one of a measurement corresponding to an object based on the standard deviation.

### BACKGROUND

Vehicles use sensors to collect data while operating, the sensors including radar, LIDAR, vision systems, infrared systems, and ultrasonic transducers. Vehicles can actuate the sensors to collect data while traveling along roadways. Based on the data, it is possible to determine parameters associated with the vehicle. For example, sensor data can be indicative of objects relative to the vehicle.

### BRIEF DESCRIPTION OF THE DRAWINGS

FIG. 1 is a diagram of an example system for determining a distribution based on sensor data.

FIG. 2 is a diagram of an example server.

FIG. 3 is a diagram of an example deep neural network including a dropout layer.

FIG. 4 is a diagram of an example deep neural network including a skip connection.

FIG. 5 is a diagram of an example prediction network system including multiple prediction networks.

FIG. 6 is an example image frame of a trailer connected to a vehicle and a trailer angle value prediction generated by the prediction network system.

FIG. 7 is a diagram of an example deep neural network.

FIG. 8 is a flow diagram illustrating an example process for determining a standard deviation from multiple predictions generated by the prediction network system.

### DETAILED DESCRIPTION

Vehicle sensors can provide information about a vehicle's surrounding environment, and computers can use sensor data detected by the vehicle sensors to process data and thereby estimate one or more physical parameters pertaining to the surrounding environment. Data processing can include regression, object detection, object tracking, image segmentation, semantic and instance segmentation. Regression includes determining a continuous or real valued variable based on the input data. Object detection can include determining labels corresponding to objects in an environment around a vehicle. Object tracking includes determining locations for one or more objects over a time series of images, for example. Image segmentation includes determining labels for a plurality of regions in an image. Instance segmentation is image segmentation where each instance of a type of object such as a vehicle is labeled separately. Some vehicle computers may use machine learning techniques including deep learning techniques to assist in classifying objects and/or estimating physical parameters using deep neural networks. In addition, classifying objects and/or estimating physical parameters in an environment around a vehicle can be performed by cloud-based computers and edge computers. Edge computers are computing devices typically positioned close to roadways or other locations where vehicles operate and can be equipped with sensors to monitor vehicle traffic and communicate with vehicles via wireless or cellular networks. However, these machine learning techniques may not have access to ground truth data and/or absolute values during operation, which could result in incorrect classifications and/or estimations in real-time.

Techniques described herein improve deep learning techniques that classify objects and estimate physical parameters by adding additional deep learning techniques that determine a confidence level corresponding to the physical parameters. In an example technique discussed herein, a deep neural network is trained to determine object data in vehicle sensor data corresponding to a vehicle trailer and estimate a trailer angle at which the vehicle trailer is attached to the vehicle. A second deep neural network is trained to determine one or more confidence levels corresponding to the trailer angle and output a value corresponding to a standard deviation of the one or more confidence levels. Outputting the standard deviation of one or more confidence levels improves the determination of prediction error in the trailer angle measure over outputting a single confidence level.

A system comprises a computer including a processor and a memory, and the memory including instructions such that the processor is programmed to calculate a standard deviation of a plurality of predictions, wherein each prediction of the plurality of predictions is generated by a different deep neural network using sensor data; and determine at least one of a measurement corresponding to an object based on the standard deviation.

In other features, the processor is further programmed to compare the standard deviation of the distribution with a predetermined variation threshold; and transmit, to a server, the sensor data when the standard deviation is greater than the predetermined variation threshold.

In other features, the processor is further programed to disable an autonomous vehicle mode of a vehicle when the standard deviation is greater than the predetermined distribution variation threshold.

In other features, the processor is further programmed to operate the vehicle when the standard deviation is less that the predetermined distribution variation threshold.

In other features, the processor is further programmed to receive the sensor data from a vehicle sensor of a vehicle; and provide the sensor data to each deep neural network.

In other features, each deep neural network comprises a convolutional neural network.

In other features, the processor is further programmed to provide an image captured by an image sensor of a vehicle to each convolutional neural network; and calculate the plurality of predictions based on the image.

In other features, the processor trains the deep neural network using dropout layers.

In other features, three or more deep neural networks are determined based on the trained deep neural network using skip functions to generate results.

In other features, the skip functions generate the three or more deep neural networks using common layers and different layers.

In other features, the skip functions are determined based on a binomial distribution.

In other features, layer weights are multiplied by an inverse retention probability function following matrix multiplication by the skip function.

In other features, an output prediction is determined based on a mean of the plurality of predictions.

In other features, the object comprises at least a portion of a trailer connected to a vehicle and the measurement comprises a trailer angle.

A system comprises a server and a vehicle including a vehicle system, the vehicle system comprising a computer including a processor and a memory, the memory including instructions such that the processor is programmed to calculate a standard deviation of a plurality of predictions, wherein each prediction of the plurality of predictions is generated by a different deep neural network using sensor data; and determine at least one of a measurement corresponding to an object based on the standard deviation.

In other features, the processor is further programmed to compare the standard deviation of the distribution with a predetermined variation threshold; and transmit, to a server, the sensor data when the standard deviation is greater than the predetermined variation threshold.

In other features, the processor is further programed to disable an autonomous vehicle mode of a vehicle when the standard deviation is greater than the predetermined distribution variation threshold.

In other features, the processor is further programmed to receive the sensor data from a vehicle sensor of a vehicle; and provide the sensor data to each deep neural network.

In other features, each deep neural network comprises a convolutional neural network.

In other features, the processor is further programmed to provide an image captured by an image sensor of a vehicle to each convolutional neural network; and calculate the plurality of predictions based on the image.

In other features, the processor is further programmed to train the deep neural network using dropout layers.

In other features, three or more deep neural networks are determined based on the trained deep neural network using skip functions to generate results.

In other features, the skip functions generate the three or more deep neural networks using common layers and different layers.

In other features, the skip functions are determined based on a binomial distribution.

In other features, layer weights are multiplied by an inverse retention probability function following matrix multiplication by the skip function.

In other features, an output prediction is determined based on a mean of the plurality of predictions

In other features, the object comprises at least a portion of a trailer connected to a vehicle and the measurement comprises a trailer angle.

A method includes calculating a standard deviation of a plurality of predictions, wherein each prediction of the plurality of predictions is generated by a different deep neural network using sensor data; and determining at least one of a measurement corresponding to an object based on the standard deviation.

In other features, the method includes comparing the standard deviation of the distribution with a predetermined variation threshold; and transmitting, to a server, the sensor data when the standard deviation is greater than the predetermined variation threshold.

In other features, the method includes disabling an autonomous vehicle mode of a vehicle when the standard deviation is greater than the predetermined distribution variation threshold.

In other features, the method includes receiving the sensor data from a vehicle sensor of a vehicle; and providing the sensor data to each deep neural network.

In other features, each deep neural network comprises a convolutional neural network.

In other features, the method includes providing an image captured by an image sensor of a vehicle to each convolutional neural network; and calculating the plurality of predictions based on the image.

In other features, the method includes training the deep neural network using dropout layers.

In other features, the method includes determining three or more deep neural networks based on the trained deep neural network using skip functions to generate results.

In other features, the method includes generating the three or more deep neural networks using skip functions to generate common layers and different layers.

In other features, the method includes determining the skip functions based on a binomial distribution.

In other features, the method includes multiplying the layer weights by an inverse retention probability function following matrix multiplication by the skip function.

In other features, the method includes determining an output prediction based on a mean of the plurality of predictions

In other features, the method includes an object that includes at least a portion of a trailer connected to a vehicle and the measurement comprises a trailer angle.

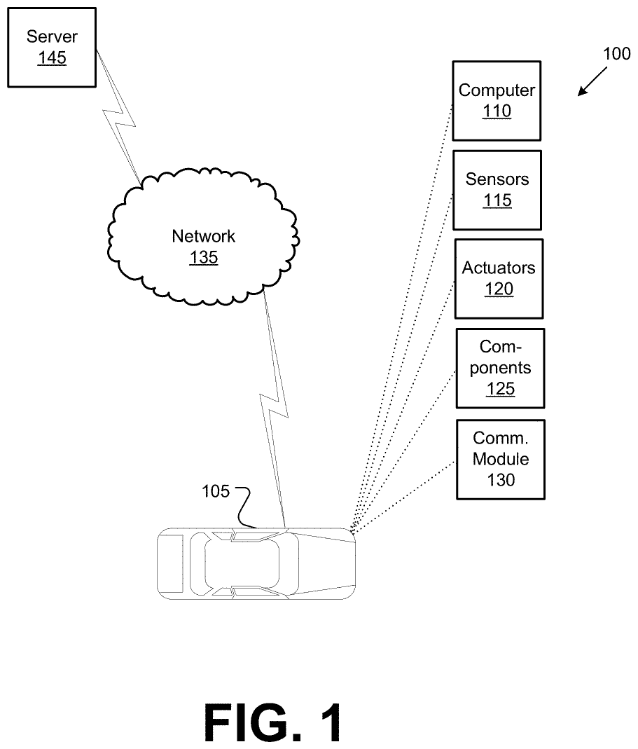

FIG. 1 is a block diagram of an example vehicle control system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer-readable media, and stores instructions executable by the computer 110 for performing various operations, including as disclosed herein.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g. front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications to another vehicle, to (typically via the network 135) a remote server 145. The computer 110 can be configured to communicate using blockchain technology to improve data security. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The network 135 includes one or more mechanisms by which a computer 110 may communicate with a server 145. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

The server 145 can be a computing device, i.e., including one or more processors and one or more memories, programmed to provide operations such as disclosed herein. Further, the server 145 can be accessed via the network 135, e.g., the Internet or some other wide area network.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to detect and identify a type of object. The objects identified can include vehicles, including three-dimensional (3D) vehicle pose, a pedestrian, road debris including rocks and potholes, bicycles, motorcycles, and traffic signs, etc. Object detection can include scene segmentation as well as physical features of objects including construction zone detection.

Various techniques such as are known may be used to interpret sensor 115 data. For example, camera and/or lidar image data can be provided to a classifier that comprises programming to utilize one or more image classification techniques. For example, the classifier can use a machine learning technique in which data known to represent various objects, is provided to a machine learning program for training the classifier. Once trained, the classifier can accept as input an image and then provide as output, for each of one or more respective regions of interest in the image, an indication of one or more objects or an indication that no object is present in the respective region of interest. Further, a coordinate system (e.g., polar or cartesian) applied to an area proximate to a vehicle 105 can be applied to specify locations and/or areas (e.g., according to the vehicle 105 coordinate system, translated to global latitude and longitude geo-coordinates, etc.) of objects identified from sensor 115 data. Yet further, a computer 110 could employ various techniques for fusing data from different sensors 115 and/or types of sensors 115, e.g., lidar, radar, and/or optical camera data.

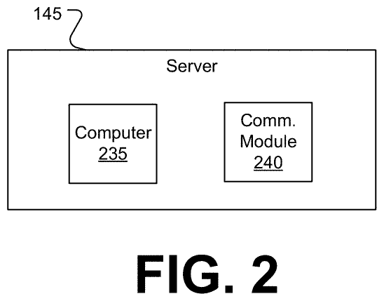

FIG. 2 is a block diagram of an example server 145. The server 145 includes a computer 235 and a communications module 240. The server 145 can be included in an edge computer, for example. The computer 235 includes a processor and a memory. The memory includes one or more forms of computer-readable media, and stores instructions executable by the computer 235 for performing various operations, including as disclosed herein. The communications module 240 allows the computer 235 to communicate with other devices, such as the vehicle 105.

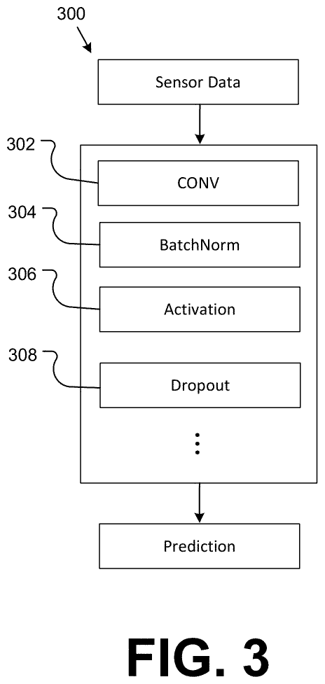

The computer 110 can generate a distribution representing one or more outputs and predict an output based on the distribution using a machine learning program. FIG. 3 illustrates an example deep neural network (DNN) 300. The DNN 300 can be a software program that can be loaded in memory and executed by a processor included in computer 110, for example. In an example implementation, the DNN 300 can include, but is not limited to, a convolutional neural network (CNN), R-CNN (regions with CNN features), Fast R-CNN, and Faster R-CNN. In some examples the DNN 200 can be configured to process natural language.

As shown in FIG. 3, the DNN 300 can include one or more convolutional layers and one or more batch normalization layers (CONV/BatchNorm) 302, and one or more activation layers 306. The convolutional layers 302 can include one or more convolutional filters that are applied to an image to provide image features. The image features can be provided to the batch normalization layers 302, and the batch normalization layers 302 normalizes the image features. The normalized image features can be provided to the activation layers 306, and the activation layers 306 comprise an activation function, e.g., a piecewise linear function, that generates an output based on the normalized images. The output of the rectified linear unit layers 306 can be provided to a dropout layer 308 as input to generate the predicted domain, such as a trailer angle.

The dropout layer 308 can comprise the final layer of the DNN 300 that removes, e.g., “drops out,” one or more nodes from the DNN 300 during training, e.g., temporarily removing the one or more nodes from the DNN 300, including incoming and outgoing connections. The selection of which nodes to drop from the DNN 300 may be random. Applying dropout to the DNN 300 improves training of the DNN 300 by temporarily disabling a portion of the nodes of a layer. While only a single convolutional layer 302, batch normalization layer 302, activation layer 306, and dropout layer 308 is shown, the INN 300 can include additional layers depending on the implementation of the DNN 300.

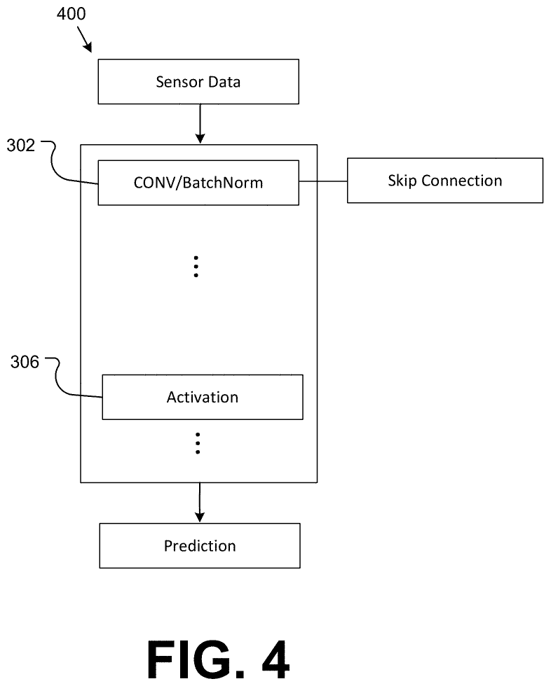

FIG. 4 illustrates a DNN 400 can include one or more convolutional layers (CONV) 302, one or more batch normalization layers (BatchNorm) 302, one or more skip connections 402, and one or more activation layers 306. As shown, the skip connections 402 are between the convolutional layers/batch normalization layers 302 and the activation layers 306. The skip connections 402 can be defined as a connection structure in which a value input to a layer of the DNN 400 is combined with a value output from another layer of the DNN 400 by matrix multiplication. For example, the skip connections 402 feed an output of one layer as input to one or more later layers of the DNN 400, Equation 1 illustrates an example skip connection calculation:

$${[ \begin{matrix}0.3 & 0.45 & … & 0.76 & 0.21 \\ & & … & & \\ 0.67 & 0.98 & … & 0.23 & 0.54\end{matrix} ]}_{Initial Layer Weights} \times {[ \begin{matrix}0 & 1 & … & 1 & 1 \\ & & … & & \\ 1 & 1 & … & 1 & 0\end{matrix} ]}_{{Skip Function}_{Generated Output}} \times {( \frac{1}{Retention Probability} )}_{Retention Probability} = {[ \begin{matrix}0 & 0.45 & … & 0.76 & 0.21 \\ & & … & & \\ 0.67 & 0.98 & … & 0.23 & 0\end{matrix} ]}_{Output Layer Weights} \qquad Eq . 1$$

A skip connection 402 receives one or more weights for the DNN 400 and a retention probability. The skip connection 402 can use a probability distribution including a binomial distribution to find index locations for the weights via the retention probability. The inverse of the retention probability is used to upscale the output layer weights to provide unity gain. As shown, matrix multiplication is applied to identify retained neurons within the DNN 400, and the resultant weights are upscaled by a factor of (1/retention probability). The retention probability can vary between 0.95 and 1.00 in example implementations. By varying the retention probability, a desired correlation between the prediction error and the standard deviation can be achieved without having any information about the ground truth. Using skip connections 402 reduces computing resources and time required to train the DNNs by generating three or more separate DNNs 400 (three or more models) from a single trained DNN 400. Dropout layers 308 reduces overfitting, where a DNN learns to identify input objects based on image noise or other non-essential aspects of an input image. Dropout layers 308 can force a DNN 400 to learn only essential aspects of input images, thereby improving the training of a DNN 400.

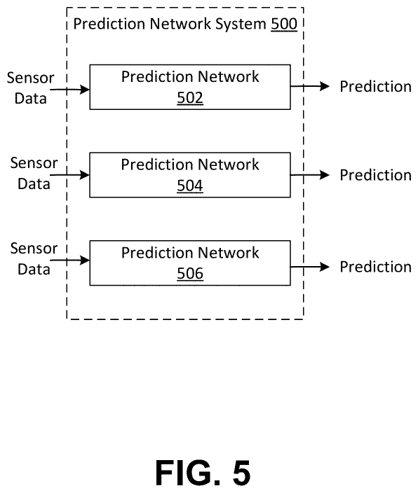

FIG. 5 illustrates an example prediction network system 500 that includes a first prediction network 502, a second prediction network 504, and a third prediction network 506. The prediction networks 502, 504, 506 are obtained by initially training a DNN 300 using one or more dropout layers 308 and replacing the dropout layers 308 with skip connections 402 as shown in FIG. 4. In other examples, a single DNN 300 can be trained with or without dropout layers 308. Once trained, skip connections 402 are applied to the single trained DNN 300 to generate first, second and third prediction networks 502, 504, 506 by skipping one or more different layers in the DNN 300 to produce results which are similar, but typically not exactly the same. A standard deviation determined based on the three output results corresponds to an error or the uncertainty of the values output from the three prediction networks 503, 504, 506, while the mean or median of the three outputs is equal to the predicted measurement.

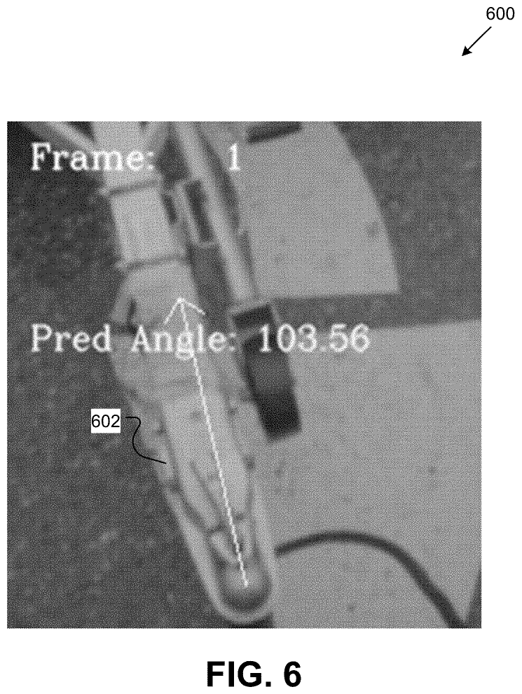

During operation, the computer 110 can generate one or more predictions via the prediction network 500. In an example implementation, the prediction network system 500 receives sensor 115 data, such as an image 600 of a trailer 602 as shown in FIG. 6. In an example implementation, the sensors 115 of the vehicle 105 can capture an image of a position of the trailer 602 with respect to the sensors 115. The vehicle 105 computer 110 provides the image 602 to the prediction network system 500, and the prediction network system 500 generates a plurality of predicted trailer angle values based on the image 602. Once the plurality of predicted trailer angle values is generated, the computer 110 can determine the distribution, e.g., the standard deviation, of the predicted trailer angle values and/or the average or median values of the predicted trailer angle values as discussed below. The computer 110 may determine, or assign, an output value based on the average values. For example, the computer 110 may calculate the mean of the predicted trailer angle values and assign the calculated mean as the trailer angle output value. As shown in FIG. 6, the trailer angle output value is 103.56 degrees.

Each prediction network 502, 504, 506 generates a prediction based on the received sensor 115 data. For example, each prediction network 502, 504, 506 calculates a respective prediction representing an angle of the trailer 602 relative to the vehicle 105. Using each prediction from the prediction networks 502, 504, 506, the computer 110 calculates the standard deviation and the average values, e.g., the mean, the mode, and the median, of the predictions. Based on the standard deviation, the computer 110 can determine a confidence parameter. In an example, the computer 110 assigns a “high” confidence parameter when the standard deviation is less than or equal to a predetermined distribution variation threshold and assigns a “low” confidence parameter when the standard deviation is greater than the predetermined distribution variation threshold. A “low” confidence parameter may be indicative that the prediction network 500 has not been trained with similar input data. Images corresponding to the “low” confidence parameter may be provided to the server 145 for further prediction network 500 training. Alternatively or additionally, the computer 110 determines an output based on the standard deviations. For example, the computer 110 may use an average of the predictions to generate an output, e.g., object prediction, object classification, or the like.

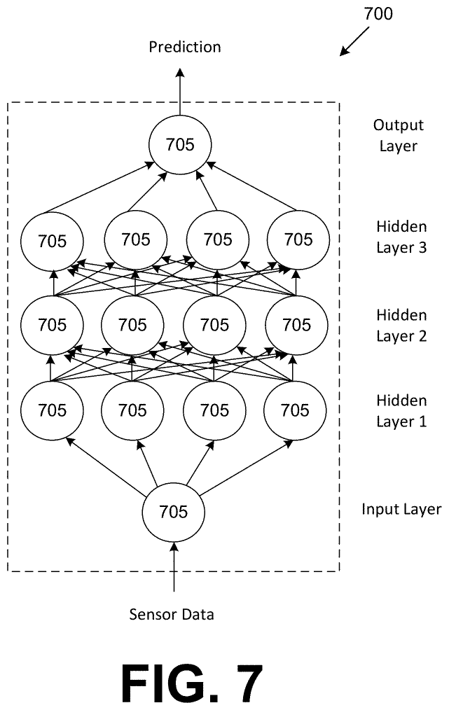

FIG. 7 illustrates an example deep neural network (DNN) 700 that can perform the functions described above and herein. For example, the prediction networks 502, 504, 506 are three separate models that can each be implemented by selecting some common layers and some different layers from a single trained DNN 700. The DNN 700 can be a software program that can be loaded in memory and executed by a processor included in the computer 110 or the server 145, for example. In an example implementation, the DNN 800 can include, but is not limited to, a convolutional neural network (CNN), R-CNN (regions with CNN features), Fast R-CNN, Faster R-CNN, and recurrent neural networks (RNNs). The DNN 700 includes multiple nodes 705, and the nodes 705 are arranged so that the DNN 700 includes an input layer, one or more hidden layers, and an output layer. Each layer of the DNN 700 can include a plurality of nodes 705. While FIG. 7 illustrates three (3) hidden layers, it is understood that the DNN 700 can include additional or fewer hidden layers. The input and output layers may also include more than one (1) node 705.

The nodes 705 are sometimes referred to as artificial neurons 705, because they are designed to emulate biological, e.g., human, neurons. A set of inputs (represented by the arrows) to each neuron 705 are each multiplied by respective weights. The weighted inputs can then be summed in an input function to provide, possibly adjusted by a bias, a net input. The net input can then be provided to activation function, which in turn provides a connected neuron 705 an output. The activation function can be a variety of suitable functions, typically selected based on empirical analysis. As illustrated by the arrows in FIG. 7, neuron 705 outputs can then be provided for inclusion in a set of inputs to one or more neurons 705 in a next layer.

The DNN 700 can be trained to accept data, e.g., from the vehicle 105 CAN bus, sensors, or other network, as input and generate a distribution of possible outputs based on the input. The DNN 700 can be trained with ground truth data, i.e., data about a real-world condition or state. For example, the DNN 700 can be trained with ground truth data or updated with additional data by a processor of the server 145. The DNN 700 can be transmitted to the vehicle 105 via the network 135. Weights can be initialized by using a Gaussian distribution, for example, and a bias for each node 805 can be set to zero. Training the DNN 700 can including updating weights and biases via suitable techniques such as back-propagation with optimizations. Ground truth data can include, but is not limited to, data specifying objects within an data or data specifying a physical parameter, e.g., angle, speed, distance, or angle of object relative to another object.

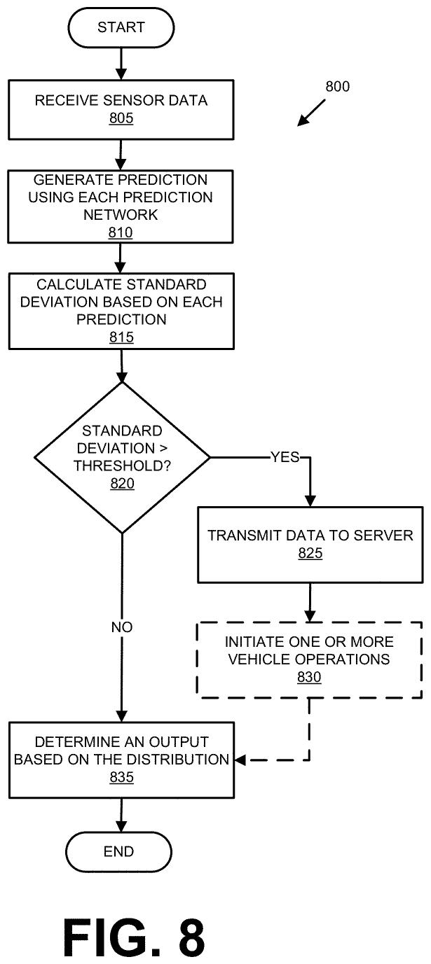

FIG. 8 is a flowchart of an exemplary process 800 for generating a standard deviation on the plurality of predictions and generating an output based on the distribution. Blocks of the process 800 can be executed by the computer 110. The process 800 begins at block 805 in which the computer 110 receives sensor data from the sensors 115. For example, the sensor data may be image frames captured by a camera sensor 115. The prediction network system 500 generates a prediction using the sensor 115 data at block 810. For example, each prediction network 502, 504, 506 generates a respective prediction based on the received sensor 115 data prediction based on an image captured by the sensors 115.

At block 815, the computer 110 calculates a standard deviation based on each prediction. In some implementations, a moving window average can be applied to the standard deviation. By applying the moving window average, the computer 110 can remove outliers within the sensor 115 data. The computer 110 determines whether a distribution variation corresponding to the standard deviation is greater than a predetermined distribution variation threshold at block 820. If the distribution variation is greater than the predetermined distribution variation threshold, e.g., a low confidence parameter, the computer 110 transmits the sensor data to the server 145 via the network 135 at block 825. In this context, the server 145 may use the sensor data for additional training of the prediction network system 500 since the standard deviation for the sensor data is relatively higher. Optionally, at block 830, the computer 110 may disable one or more autonomous vehicle 105 modes. For example, a traction control system, a lane keeping system, a lane change system, speed management, etc., could be disabled as a result of the distribution variation being greater than the predetermined distribution variation threshold. Yet further, for example, vehicle 105 features allowing a semi-autonomous “hands-off” mode in which an operator could have hands off a steering wheel could be disabled when the distribution variation is greater than the predetermined distribution variation threshold.

Otherwise, if the distribution variation is less than or equal to the predetermined distribution variation threshold, the computer 110 determines an output based on the distribution. For example, the computer 110 may determine a physical measurement, e.g., trailer angle relative to the vehicle 105, distance between an object and the vehicle 105, based on the sensor 115 data. In some implementations, the computer 110 assigns a high confidence parameter to the predictions. The process 800 then ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), or a distributed database, etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
calculate a standard deviation of a plurality of predictions, wherein each prediction of the plurality of predictions is generated by a different deep neural network using sensor data; and
determine at least one of a measurement corresponding to an object based on the standard deviation.

2. The system of claim 1, wherein the processor is further programmed to:
compare the standard deviation of a distribution with a predetermined variation threshold; and
transmit, to a server, the sensor data when the standard deviation is greater than the predetermined variation threshold.

3. The system of claim 2, wherein the process is further programmed to:
disable an autonomous vehicle mode of a vehicle when the standard deviation is greater than a predetermined distribution variation threshold.

4. The system of claim 1, wherein the processor is further programmed to:
receive the sensor data from a vehicle sensor of a vehicle; and
provide the sensor data to each deep neural network.

5. The system of claim 1, wherein each deep neural network comprises a convolutional neural network.

6. The system of claim 5, wherein the processor is further programmed to:
provide an image captured by an image sensor of a vehicle to each convolutional neural network; and
calculate the plurality of predictions based on the image.

7. The system of claim 1, wherein the object comprises at least a portion of a trailer connected to a vehicle and the measurement comprises a trailer angle.

8. A system comprising:
a server; and
a vehicle including a vehicle system, the vehicle system comprising a computer including a processor and a memory, the memory including instructions such that the processor is programmed to:
calculate a standard deviation of a plurality of predictions, wherein each prediction of the plurality of predictions is generated by a different deep neural network using sensor data; and
determine at least one of a measurement corresponding to an object based on the standard deviation.

9. The system of claim 8, wherein the processor is further programmed to:
compare the standard deviation of a distribution with a predetermined variation threshold; and
transmit, to the server, the sensor data when the standard deviation is greater than a predetermined variation threshold.

10. The system of claim 9, wherein the process is further programmed to:
disable an autonomous vehicle mode of a vehicle when the standard deviation is greater than the predetermined distribution variation threshold.

11. The system of claim 8, wherein the processor is further programmed to:
receive the sensor data from a vehicle sensor of a vehicle; and
provide the sensor data to each deep neural network.

12. The system of claim 8, wherein each deep neural network comprises a convolutional neural network.

13. The system of claim 12, wherein the processor is further programmed to:
provide an image captured by an image sensor of a vehicle to each convolutional neural network; and
calculate the plurality of predictions based on the image.

14. The system of claim 8, wherein the object comprises at least a portion of a trailer connected to a vehicle and the measurement comprises a trailer angle.

15. A method comprising:
calculating a standard deviation of a plurality of predictions, wherein each prediction of the plurality of predictions is generated by a different deep neural network using sensor data; and
determining at least one of a measurement corresponding to an object based on the standard deviation.

16. The method of claim 15, further comprising:
comparing the standard deviation of a distribution with a predetermined variation threshold; and
transmitting, to a server, the sensor data when the standard deviation is greater than the predetermined variation threshold.

17. The method of claim 16, further comprising:
disabling an autonomous vehicle mode of a vehicle when the standard deviation is greater than a predetermined distribution variation threshold.

18. The method of claim 15, further comprising:
receiving the sensor data from a vehicle sensor of a vehicle; and
providing the sensor data to each deep neural network.

19. The method of claim 15, wherein each deep neural network comprises a convolutional neural network.

20. The method of claim 19, further comprising:
providing an image captured by an image sensor of a vehicle to each convolutional neural network; and
calculating the plurality of predictions based on the image.
